(19) United States
(12) Patent Application Publication
(10) Pub. No.: US 2008/0310930 A1
(43) Pub. Date: Dec. 18, 2008

(54) Method, Anchor and Drill for Anchoring the Anchor in an Anchoring Substrate

(76) Inventors: Marc Schaeffer, Horb-Bildechingen (DE); Oliver Hacker, Horb (DE); Diethard Fohr, Winnenden (DE); Achim Hess, Korb (DE)

Correspondence Address: MICHAEL J. STRIKER, 103 EAST NECK ROAD, HUNTINGTON, NY, 11743, US

(21) Appl. No.: 11/569,856

(22) PCT Filed: Jun. 1, 2005
(86) PCT No.: PCT/EP2005/005880

§ 371 Date: Aug. 28, 2008

(30) Foreign Application Priority Data
Jun. 3, 2004 (EP) 04013086.6
Jun. 3, 2004 (EP) 04013087.4
Jul. 7, 2004 (DE) 10 2004 033 026.3

(51) Int. Cl. F16B 13/06; E04C 5/00; E21B 10/36

(52) U.S. Cl. 411/55; 52/704; 175/395

(57) ABSTRACT

The invention relates to a method for anchoring an anchor (10) in an anchoring substrate (26), for example, of concrete, to an anchor (10) suitable for the method and to a drill suitable for the method. The invention proposes using the anchor (10) as tool for at least partial preparation of the anchoring hole (28) in the anchoring substrate (26) by high-frequency oscillatory working. The anchor (10) is, for example, an undercut expansion anchor, the expansible sleeve (14) of which forms the tool and is driven into an anchoring substrate (26) by being subjected to the action of high-frequency oscillations.

The invention relates to a method for anchoring an anchor in an anchoring substrate having the features of the preamble of claim 1. Furthermore, the invention relates to an anchor having the features of the preamble of claim 8 suitable for the method according to the invention and to a drill having the features of the preamble of claim 18 suitable for implementing the method.

The invention is directed in particular to an anchoring in concrete, stone, stone-like substances, masonry and similar materials as the anchoring substrate, that is, to an anchoring in the building trade. It is well-known and common practice to drill a drill hole as anchoring hole in the anchoring substrate using a percussion drill or a rotary hammer and then to insert an anchor in the anchoring hole and anchor it. The term “anchor” within the meaning of the invention is to be understood very broadly and is generally to denote elements that are anchorable, i.e. fixable, in an anchoring hole and with which an article is fixable to the anchoring substrate. Such anchors, which may also be referred to as (expansible) fixings, are, for example, expansion anchors having an expansible sleeve and an expander cone, wherein by pushing the expansible sleeve onto the expander cone, or conversely by drawing the expander cone into the expansible sleeve, the expansible sleeve is expandable and consequently anchorable in a drilled hole/anchoring hole. The anchoring is at any rate in a cylindrical anchoring hole predominantly non-interlocking, roughness or irregularity in the wall of a hole producing additionally an interlocking fit. The anchoring hole can also have a widening, which forms an undercut behind which an undercut anchor engages with an interlocking fit.

The invention is based on the technical problem of proposing an alternative anchoring option.

That problem is solved in accordance with the invention by the features of claims 1, 8 and 18. It is a fundamental concept of the invention to produce an anchoring hole for anchoring an anchor by high-frequency oscillatory working of the anchoring substrate and in the process to use the anchor as tool. The oscillation is here preferably a longitudinal oscillation, but additionally or exclusively a transverse oscillation and/or a torsional oscillation are also possible.

The method according to the invention provides for the anchoring hole to be prepared in the anchoring substrate at least partly by action on the anchoring substrate with high-frequency mechanical oscillations, especially in the ultrasonic range. High-frequency means an oscillation frequency of approximately 10 kHz or more, the ultrasonic range is considered to be located between approximately 20 kHz and 1000 MHz. The anchor to be anchored itself forms a tool for high-frequency mechanical oscillatory working of the anchoring substrate, i.e. for preparing the anchoring hole, and can also be referred to as a sonotrode. Alternatively, just a part of the anchor can form the tool, for example, the expansible sleeve or the expander cone of an expansion anchor. Partial preparation of the anchoring hole is to be understood to mean that, for example, only a widening of the anchoring hole, which forms an undercut for the interlocking anchoring of an undercut expansion anchor, is produced by the high-frequency oscillatory working, after an anchoring hole, for example a cylindrical anchoring hole, has previously been drilled in a conventional manner with a percussion drill or a rotary hammer.

The invention has several advantages, one of more of which is realised in dependence on how the invention is carried out. One advantage of the invention is that preparation of the anchoring hole and anchoring of the anchor can be performed in one operation, wherein the anchoring hole can be cleared of “drilling waste” by suction during preparation of the anchoring hole. This simplifies and speeds up the anchoring of an anchor in an anchoring substrate. Another advantage is that only one tool, namely, a vibration drill, is required for the anchoring. The two above advantages are particularly effective if the anchoring hole in its entirety is prepared by oscillatory working. A further advantage of the invention is that the preparation of the anchoring hole by high-frequency oscillatory working does not necessitate any rotary movement of the tool, i.e. of the anchor used as tool. Accordingly, the anchoring hole need not have a circular cross-section; on the contrary, any desired cross-sections of the anchoring hole are in point of fact possible. The invention also allows the cross-section of the anchoring hole to change over its depth. A further advantage of the invention is that the oscillatory excitation of the anchor forming the tool prevents jamming of the anchor as it is being driven into and is expanding in the anchoring hole. The anchor will always keep itself free as a result of the oscillatory excitation. For example, an expansible sleeve of an expansion anchor is prevented from becoming jammed in an annular gap between the expander cone and the wall of a hole as the expansible sleeve is pushed onto an expander cone. There is a particular risk of jamming in conventional anchoring when the expansible sleeve is expanded into an undercut, for example a conical widening, of the anchoring hole. A further advantage of the invention is that tool wear becomes irrelevant. The anchor used as tool is used only once; it forms as it were a disposable tool for preparation of the anchoring hole, in which it remains as anchor. The durability of the anchor is sufficient for preparation of the anchoring hole; it may, if necessary, have an extra wearing part. An expensive and wear-resistant drilling tool is at any rate unnecessary when the anchoring hole in its entirety is prepared by oscillatory working. The dimensional accuracy of the anchoring hole is also improved by the single use of the anchor as tool compared with a drill bit subject to wear (or worn).

In one embodiment of the method according to the invention, the anchor used as tool for preparation of the anchoring hole is excited with at least approximately a natural oscillation frequency of the anchor or of all parts of a vibration drill oscillating with the anchor including the anchor, that is, at least approximately in resonance with an oscillation exciter. Material to be dislodged or abraded is abraded at this resonant frequency by impact, supported if need be also by cutting. The anchor oscillating at its natural oscillation frequency performs oscillations of small amplitude and high efficiency, wherein to excite these oscillations in consequence of the resonance effect only very small exciter amplitudes of, for example, 20 μm (micrometres) are required. The high-frequency excitation of small amplitude leads to a low mechanical and acoustic impact on the environment. A vibration drill can easily be guided by hand. Anchoring holes of different contour can be made with precision and accuracy.

The anchor used as tool is intended to remain in the anchoring hole it produces. The anchor made to perform resonant oscillations abrades the material of the anchoring substrate exactly in its own circumferential contour. An anchoring hole closely surrounding the anchor is produced, in which the anchor is able to develop high clamping forces. This applies also to honeycomb or hollow bricks, pumice or the like, in which, when using conventional drilling techniques, crumbling cause overlarge bores to be produced. After preparing the anchoring hole, the anchor can temporarily be removed again in order to clear away dust or the like from the anchoring hole. Advantageously, after reaching a specified drilling depth the anchor is unclamped from the vibration drill and left in the anchoring hole. Damage to the walls of the hole in soft anchoring substrates, such as aerated concrete, plaster or the like, is avoided. A new anchor is inserted for each anchoring, so that dimensional tolerances of the anchoring hole due to wear cannot occur.

In one embodiment of the invention the anchoring hole has an undercut, which is produced by the oscillatory working with the anchor or a part of the anchor, for example, an expansible sleeve, as tool. The form of the undercut is largely arbitrary, it can be in the form, for example, of a conical or stepped widening of the anchoring hole. The anchoring hole minus the undercut can be drilled beforehand in the customary manner by drilling with a percussion drill or rotary hammer or likewise by oscillatory working. This embodiment of the invention has the advantage that an exactly fitting undercut is produced by the anchor, or by the part of the anchor that engages with an interlocking fit behind the undercut after the anchoring, as the oscillatory working tool. Preparation of the undercut is simpler than a conventional reaming to widen the anchoring hole to form an undercut through lateral displacement of a special drill bit or similar tool. The displacement, for example, of the expansible sleeve of an undercut-expansion anchor, which is used as tool to produce the undercut by high-frequency oscillatory working, is effected in a simple manner by pushing the expansible sleeve onto the expander cone whilst at the same time causing the expansible sleeve to oscillate. Feed is effected exclusively in a straight line and axially; an oscillatory motion or other lateral displacement of the tool is dispensed with. It is a further advantage that the anchor used as tool in the oscillatory working need not be driven in rotation, the undercut can therefore be other than circular, in particular it is possible to insert one or more expansion lugs at one or more circumferential points of the anchoring hole laterally into the anchoring substrate by oscillatory excitation. The undercut or undercuts are produced with an exact fit only where a part of the anchor engaging behind the undercut is located.

A further instance of application of the invention is the use of a concrete screw as anchor and tool, with which a screw thread is made in the wall of an anchoring hole in the anchoring substrate by oscillatory working. Oscillatory excitation of the concrete screw can be effected axially and/or in rotation (oscillating). The anchoring hole can be drilled conventionally beforehand, in principle it is also possible to produce the anchoring hole at the same time as the screw thread by oscillatory excitation of the concrete screw as tool. Concrete screws are known as such; conventionally, by applying pulsed rotary impact energy, they are screwed into a hole previously drilled in an anchoring substrate, the screw thread being tapped into the wall of the hole in the process. The anchoring substrate is here normally concrete or stone. A fixing plug or the like is not required; the concrete screw is screwed directly into the concrete. However, what is required is a heavy-duty and special impact screwdriver with high rotary impact energy. The core diameter of the concrete screw is smaller than the diameter of the drilled hole, there is an annular gap between the shank of the concrete screw and the wall of the drilled hole. The production according to the invention of the screw thread by (rotary) oscillatory excitation of the concrete screw as tool alleviates and facilitates screwing in of the concrete screw and the production of the screw thread.

Furthermore, the invention is directed to an anchor that is suitable for implementing the method according to the invention. The anchor according to the invention forms a tool (sonotrode) for preparation of the anchoring hole in an anchoring substrate of, for example, concrete or steel by high-frequency mechanical oscillatory excitation of the anchor and oscillatory working of the anchoring substrate. In accordance with the invention the anchor at the same time also constitutes the tool for preparing an anchoring hole for anchoring it in an anchoring substrate. The tool can also be formed by just a part of the anchor, for example, the expansible sleeve or the shank or the expander cone of an expansion anchor. The anchor according to the invention can serve as tool for preparing just a part of the anchoring hole by oscillatory working, for example, a widening of the anchoring hole forming an undercut, the anchoring hole having previously been produced in some other way, for example, by drilling.

Preferably, at least one natural oscillation frequency of the anchor is matched to the exciter frequency of a high-frequency oscillation exciter. With a small exciter amplitude of, for example, just 20 μm (micrometres) the anchoring hole can therefore be produced with great efficiency due to the resonance effect.

In one embodiment of the invention the anchor forming the tool is an undercut-expansion anchor, which in the expanded and anchored state engages behind an undercut in the anchoring hole. The invention allows anchors having a cross-section other than circular, because the anchor forming the tool need not be driven in rotation to produce the anchoring hole. The invention allows, for example, polygonal or oval anchors, which are held rotationally secure in the anchoring hole by interlocking. This has not previously been possible when drilling a cylindrical or even undercut anchoring hole.

In a preferred embodiment of the invention, the anchor is a concrete screw, which forms the tool. By high-frequency oscillatory excitation the concrete screw itself cuts its screw thread into the anchoring substrate. Here too, the effective advantage is that the oscillatory excitation of the concrete screw prevents jamming, production of the screw thread is therefore easier, the screw thread can be tapped deeper into the wall of the anchoring hole in the anchoring substrate, the gap between the shank of the concrete screw and the wall of a hole can be reduced and a shank diameter of the concrete screw consistent with the hole diameter of the anchoring hole is possible.

In a preferred embodiment of the invention, the anchor has a suction channel for extraction of stone waste that arises during the at least partial production of the anchoring hole by oscillatory working. The suction channel extends from a leading end of the anchor, that is, from a point at which the stone waste accumulates, to a rear region of the anchor, which projects out of the anchoring substrate or which is at least accessible for extraction of the stone waste by suction. The suction channel can be, for example, a groove or a closed, inner channel like a bore. The suction channel, which can also be used for blowing out and/or as feed channel for a drilling fluid, allows the anchoring hole to be cleaned as it is being produced. The drilling fluid can be in liquid or gaseous form (for example, air), and preferably has abrasive drilling auxiliaries added to it.

In an advantageous construction, the anchor has a drill head that expands automatically during drilling. In particular, for this purpose the anchor has longitudinal slits in the region of its drill head, a front end of the drill head having a recess, for example a concavely curved recess. The axial contact pressure generated on the end face of the drill head as the hole is being prepared produces via the concave curvature a radially outwardly directed expansion force, which expands the anchor radially outwardly in the region of the longitudinal slits. The expansion is effected automatically as a function of the advancement of the anchoring hole. With no additional measures an anchoring hole widening conically in the drilling direction is produced, the form of which exactly matches the anchor widening conically in the drilling direction. With no additional expansion measures, an interlocking fixing of the anchor in the anchoring hole with a high fitting accuracy is provided.

In an advantageous embodiment of the invention, the body of the anchor comprises a shank and a free end in the form of a drill head, the drill head having a non-circular cross-sectional contour projecting in a radial direction beyond the shank. In a simple manner it is possible to produce prismatic anchoring holes of non-circular cross-sectional form, corners of the non-circular drill head simply and effectively producing if applicable a desired undercut on rotation of the anchor clamped in the drill. After performing the rotary movement, in addition to being held by clamping force the anchor is reliably held by interlocking engagement in the undercut.

To produce the drilled hole, the invention provides a drill in the form of a high-frequency oscillation exciter as vibration drill. Preferably it is a hand-held unit and/or an electric drill. The (drilling) tool is here the anchor clamped in the drill, the anchor in at least one natural oscillation frequency being matched to the exciter frequency of the high-frequency oscillation exciter. The exciter frequency and the natural oscillation frequency advantageously lie above 10 KHz and especially in the ultrasonic range. In operation of the vibration drill, the oscillation exciter and the anchor forming the tool are at least approximately in resonance.

In an advantageous development, the drill has a quick-action chuck operable without tools for the anchor. The quick-action chuck can be a jaw chuck and is advantageously a collet, into which the anchor can be fitted exactly. The quick-action chuck allows a good transfer of energy between the oscillation exciter and the anchor. If a plurality of anchoring holes is to be prepared, the anchors can be clamped simply with few hand movements in the hand-operated drill without an additional tool. After producing the anchoring hole, a quick release (unclamping) of the anchor is possible. Damage to the anchoring hole as the anchor is released from the drill is avoided. The preparation of anchoring holes and the insertion of the anchors can take place in rapid cycle sequence.

The anchor advantageously has a threaded rod, with which it is held in the chuck of the drill. The anchor itself, or rather its body, can oscillate unhindered without being restricted by the chuck. A high drilling performance can be achieved. On preparation of the anchoring hole, the threaded rod with an expansion head optionally fixed thereto is inserted together with the anchor into the anchoring hole. Any additional subsequent assembly effort is dispensed with.

In one advantageous construction, the chuck of the drill is in the form of a magnetic retainer and the anchor is designed for magnetic fixing to the chuck. For that purpose it comprises especially a magnetically attractable material, preferably a soft magnetic iron material. Clamping of the anchor and also release thereof is possible with no great expenditure of energy. The magnetic force is sufficient to fix the anchor as transfer of the oscillation energy from the oscillation exciter to the anchor is brought about by surface pressure as a consequence of the contact pressure exerted by hand. The same applies correspondingly to a retention of the anchor at the chuck, in which either the anchor or the chuck comprises an auxiliary pin for attachment of the anchor.

The chuck is advantageously made of a material with low sound absorption and especially of titanium. It has been shown that in that case the oscillation energy of the oscillation exciter can be transferred to the anchor at least virtually without loss.

In one advantageous embodiment, the anchor is held statically fixed and in particular rotationally secure in the chuck of the vibration drill. The effect of the statically fixed clamping of the anchor used as tool is that its oscillatory motion effecting oscillatory working of the anchoring substrate is substantially exclusively a dynamic natural oscillation. The fixed clamping leads to a precisely defined natural oscillation frequency, which simplifies matching of the exciter frequency of the oscillation exciter to the system as a whole. Rotationally secure clamping of the anchor as the tool for producing the anchoring hole, in particular in conjunction with a non-circular drill head, allows anchoring holes having a cross-section other than circular to be prepared. On reaching the desired anchoring depth, the drill can be rotated together with the anchor clamped secure against rotation, the parts of the drill head projecting radially beyond the shank of the anchor producing an undercut of precisely defined form with respect to the non-circular core bore.

The oscillation exciter of the drill according to the invention is advantageously in the form of a piezo exciter. The electrical energy made available via a mains cable or a battery is converted with a generator unit into a high-frequency alternating voltage and converted with great efficiency by means of the piezo exciter into mechanical oscillatory energy. In combination with the high excitation and natural frequencies, high drilling performances can be achieved with comparatively little drive energy. As an electric tool, the vibration drill can be of small, light-weight and manageable construction.

It is advantageous to provide a suction device for drilling waste in the region of the anchor. The extraction device easily compensates for the lack of a drilling waste removal by a helical drilling waste groove of a drill bit, which is conventional in the art, in combination with a rotary movement of the drill bit.

In one advantageous construction of the invention, a feed device for a drilling fluid (preferably liquid, possibly gaseous) provided in particular with abrasive drilling auxiliaries is provided in the region of the anchor forming the tool. Anchors with drill heads of diverse constructions, even without cutting edges, can be used. The abrading oscillatory motion of the drill head, for example with a flat front face, is effectively assisted by the abrasive drilling auxiliaries such as diamond powder or the like. Here, the drilling fluid discharges the drilled-out material, avoiding the formation of dust.

The extraction device and the feed device advantageously each comprise a collector, which is connected to a suction/flushing channel arranged on the anchor. The suction/flushing channel can be provided on the inside or on the outer surface of the anchor. The connection of the collector to the suction/flushing channel in the anchor allows universal application. For example, air can be drawn in through the collector and the suction/flushing channel, the drilling waste abraded in the region of the drill head being extracted by suction directly at the abrasion location, thus avoiding formation of dust. Flow can also be in the reverse direction in the same arrangement. When air is the flowing medium, the drilling waste can be blown efficiently out of the drill hole. A drilling fluid, for example, in the form of water with diamond powder, can likewise be pumped through the collector and the suction/flushing channel to the drill head. Specific metering is possible. For example, with two collectors a closed system can be formed, with which air or the drilling fluid is admitted and also sucked out again.

By means of the above-mentioned drill in conjunction with the above-mentioned anchor in the form of the tool, anchoring holes can be made with precision in stone or stone-like materials such as concrete and masonry or the like. The anchor remaining in the anchoring hole fits with an exact fit in the anchoring hole it has itself produced. In particular, non-circular anchoring holes can be produced with an undercut and high dimensional accuracy, and are suitable for clamping and interlocking fixing of appropriate anchors and expansible fixings.

The invention is explained in more detail hereafter with reference to exemplary embodiments illustrated in the drawings, in which:

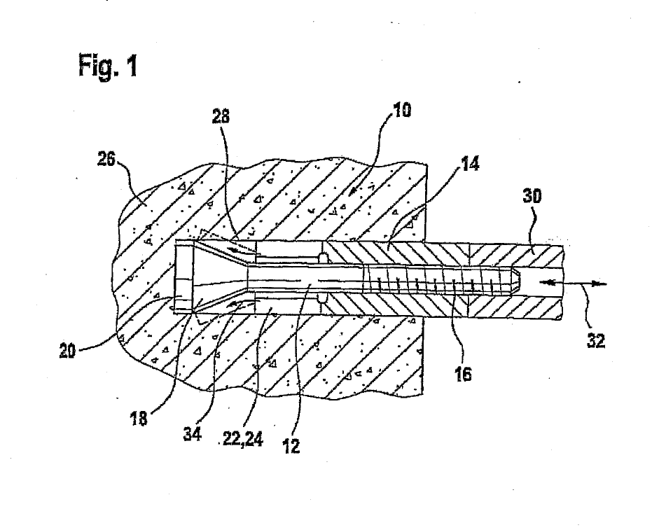

FIG. 1 shows a first anchor according to the invention;

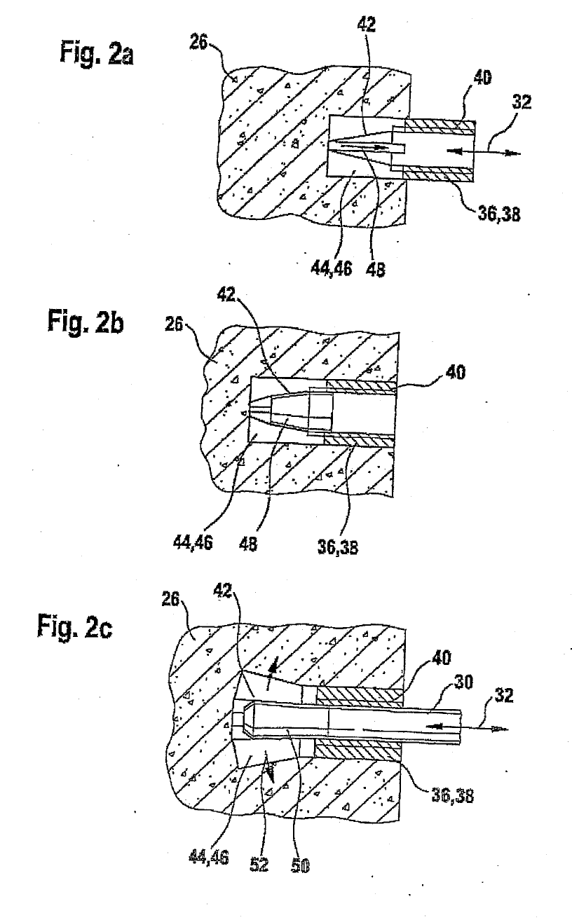

FIGS. 2a-c show a second anchor according to the invention in different anchoring steps;

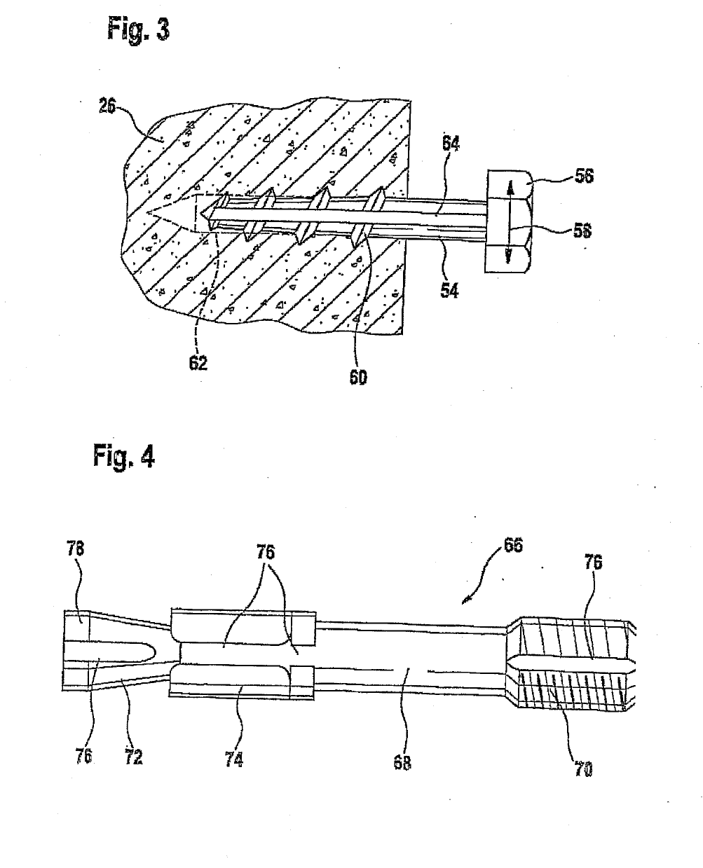

FIG. 3 shows a concrete screw according to the invention;

FIG. 4 shows a further anchor according to the invention;

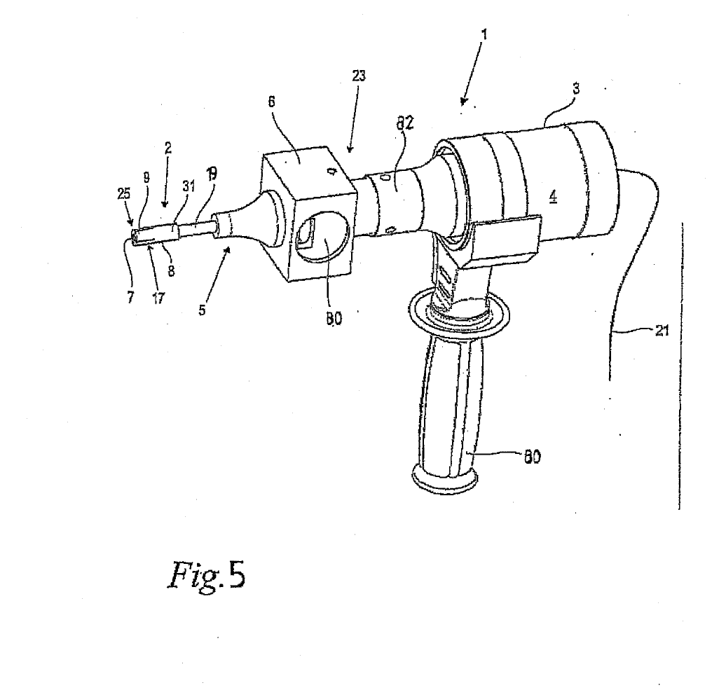

FIG. 5 shows in a schematic perspective view a hand drill with a piezo oscillation exciter and an anchor clamped rotationally secure as tool according to the invention;

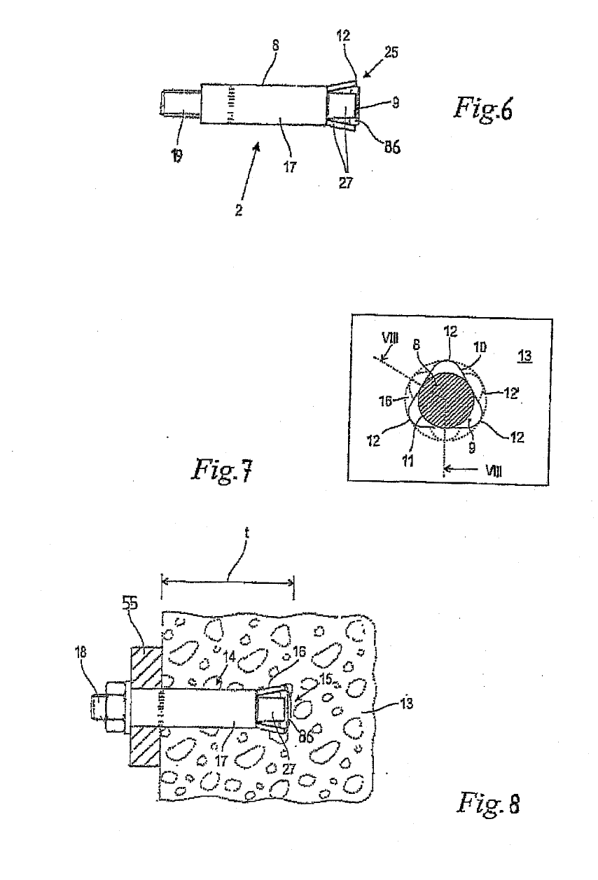

FIG. 6 shows a variant of the anchor according to FIG. 5 with a radially projecting drill head;

FIG. 7 shows in a schematic plan view an anchoring substrate with an anchoring hole of triangular construction with a circular undercut according to the invention;

FIG. 8 shows a schematic sectional view of the anchoring substrate in FIG. 7 with details of the undercut of the anchoring hole and with an anchor according to FIG. 6 inserted;

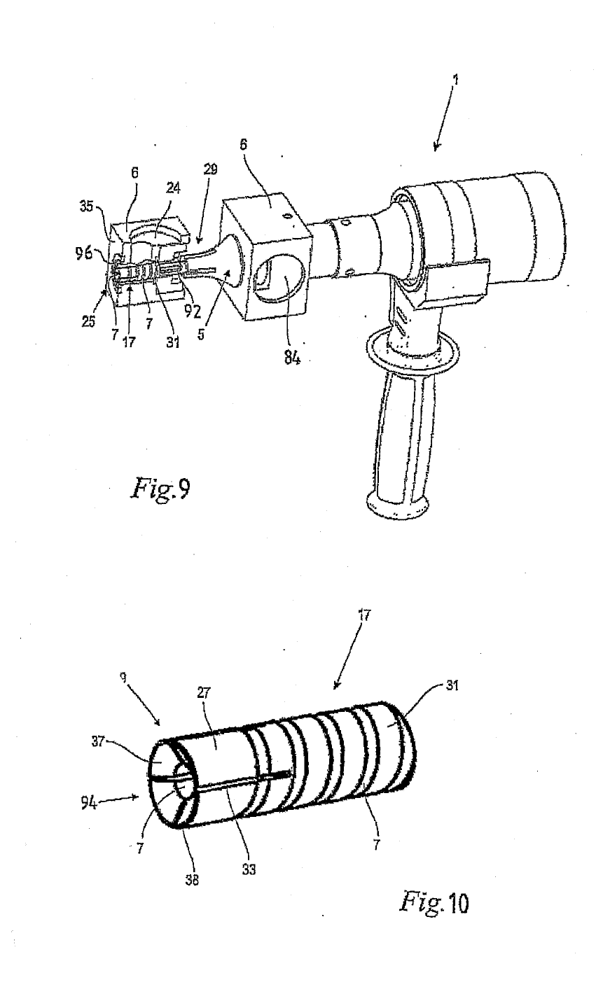

FIG. 9 shows a variant of the arrangement according to FIG. 5 with a further collector engaging around the anchor;

FIG. 10 shows in a detail view, to an enlarged scale, the anchor in FIG. 9 with details of its automatically expanding drill head according to the invention;

FIG. 11 shows details of a chuck according to FIG. 9 in the form of a collet;

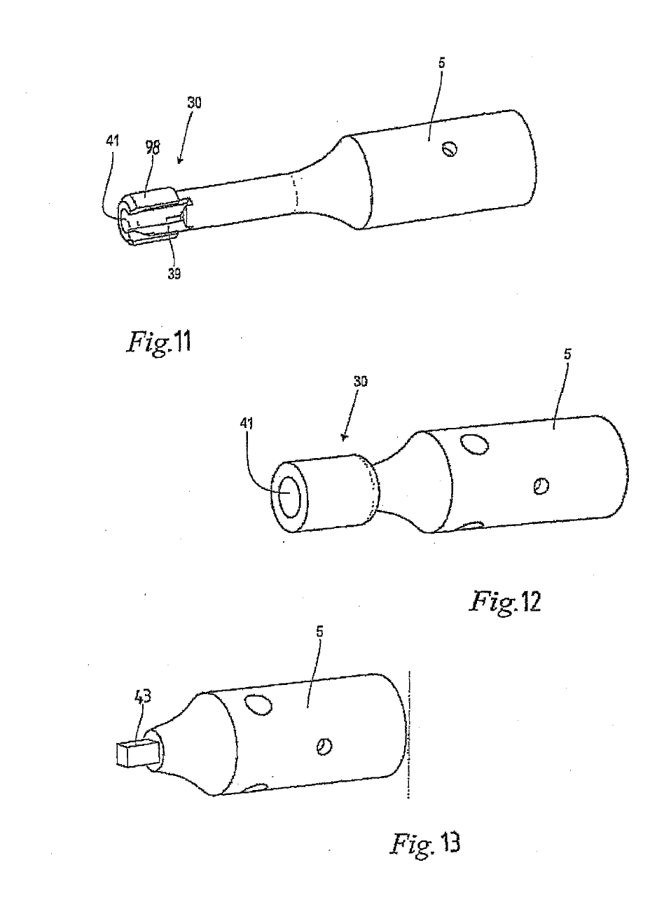

FIG. 12 shows a variant of the chuck according to FIG. 11 in the form of a magnetic retainer; and

FIG. 13 shows a further variant of the chuck according to the invention with an auxiliary pin provided for attachment of the anchor.

The anchor 10 according to the invention illustrated in FIG. 1 is an undercut expansion anchor, it comprises an anchor shank 12 and an expansible sleeve 14. At its rear end the anchor shank 12 has a screw thread 16, at its leading end it widens with an expander cone 18 and ends in a short cylindrical portion 20.

The expansible sleeve 14 is tubular, and is slidable on the shank 12. In a leading region facing the expander cone 18 the expansible sleeve 14 has slits 22 open at the front, which divide the expansible sleeve 14 into expansible lugs 24.

For anchoring in an anchoring substrate 26, for example, of concrete, the anchor 10 is introduced as illustrated in FIG. 1 into a previously drilled, cylindrical anchoring hole 28 in the anchoring substrate 26. By means of a high-frequency drill, not shown, the expansible sleeve 14 is pushed onto the expander cone 18. The high-frequency drill is or includes an oscillation exciter, which generates mechanical oscillations in the high-frequency range. High-frequency means a frequency of about 10 kHz or higher. Preferably the drill operates with oscillations in the ultrasonic range, i.e. in the range between about 20 kHz and 1000 MHz. Such oscillation exciters, also known as oscillation transducers, converters or ultrasonic converters, are known per se and therefore require no explanation here. The oscillation exciter can be a hand-held unit, for example, in the form of a hand drill. The high-frequency drill has a tubular oscillator 30, the leading end of which visible in FIG. 1 is placed on the rear end of the expansible sleeve 14 facing it. The oscillator 30 is caused by the high-frequency drill to effect axial mechanical oscillations in the ultrasonic range. The oscillations can also be interpreted as vibrations and are indicated by the double arrow 32. The oscillator 30 transfers the ultrasonic oscillations to the expansible sleeve 14 of the anchor 10. The expansible sleeve 14 caused in this way to perform ultrasonic oscillations forms a tool, which can also be referred to as a sonotrode, for ultrasonic working of the anchoring substrate 26. The ultrasonic working is to be understood as working the anchoring substrate 26 with mechanical oscillations in the ultrasonic range. Working of the anchoring substrate 26 is also possible with an oscillation frequency below the ultrasonic range, i.e. in the infrasonic range. The expansible lugs 24 of the expansible sleeve 14 are deflected obliquely outwards by the expander cone 18 in the direction of the arrows 34 and mould themselves into the wall of the anchoring hole 28, as indicated in FIG. 1 by broken lines. The ultrasonic working using the expansible sleeve 14 as tool produces a conical undercut in the anchoring hole 28, behind which the expansible lugs 24 engage. The expansion anchor 10 is consequently anchored in the anchoring substrate 26.

The (cylindrical) anchoring hole 28 can be drilled with a percussion drill or a rotary hammer. A further possibility according to the invention is the production of the anchoring hole 28 likewise by oscillatory working using the anchor shank 12 as the tool. For that purpose, the high-frequency vibration drill (not illustrated) applies high-frequency oscillations, especially ultrasonic oscillations, to the anchor shank 12, which is driven into the non-predrilled anchoring substrate 26. The anchor shank 12 can be screwed or clamped with its screw thread 16 into a tool holding fixture of the high-frequency drill (not illustrated) in order to achieve a good transfer of oscillations. According to the invention the anchoring hole 28 including the conical undercut can therefore be produced with the shank 12 and the expansible sleeve 14 of the anchor 10 as tool by oscillatory working, especially by ultrasonic working, or just the undercut of the anchoring hole 28 can be produced with the expansible sleeve 14 of the anchor as tool by oscillatory working, once the anchoring hole 28 has been produced beforehand in some other manner.

FIG. 2a shows a second anchor 36 according to the invention, which is likewise in the form of an expansible anchor. The anchor 36 comprises an expansible sleeve 38 with cylindrical outer circumference and an axial through-hole, In a rear region of the anchor 36, which extends for somewhat more than half the length of the anchor 36, the through-hole is cylindrical and has an internal screw thread 40. Towards the leading end, the through-hole tapers with a hollow cone 42. Slits 44 divide the leading region of the expansible sleeve 38 into expansible limbs 46. To produce an anchoring hole in the anchoring substrate 26, the anchor 36 is clamped in a high-frequency drill (not illustrated) or is screwed on with its internal screw thread 40 or is subjected in some other way to mechanical oscillations in the infrasonic or ultrasonic range as indicated by the double arrow 32, and driven into the non-predrilled anchoring substrate 26. Drilling waste occurring during oscillatory working of the anchoring substrate 26 can be extracted by suction through the expansible sleeve 38 as indicated by arrow 48. The axial through-hole of the expansible sleeve 38 thus forms a suction channel for extraction of drilling waste by suction.

After driving the expansible sleeve 38 into the anchoring substrate 26, as illustrated in FIG. 2b an expander cone 48 is driven into the expansible sleeve 38 and expands the expansible limbs 46 and hence anchors the expansible anchor 36 in the anchoring hole in the anchoring substrate 26. A screw or a threaded bolt (not illustrated) can be screwed into the internal screw thread 40 to fix an article (not illustrated). Here too, the anchor 36 forms a tool for producing an anchoring hole by ultrasonic or oscillatory working of the anchoring substrate 26.

A modification of the invention is shown in FIG. 2c. Here, after driving in the expansible sleeve 38 of the anchor 36 into the anchoring substrate 26 a cylindrical expansion body 50 is driven into the expansible sleeve 38. To be specific, the expansible body 50 is driven into the hollow cone 42 of the expansible sleeve 38. Driving in is again effected with a vibration drill (not illustrated), the oscillation exciter 30 of which is placed on the expansion body 50 and acts on this with, in particular, ultrasonic oscillations. The ultrasonic oscillations are transferred to the expansible limbs 46 of the anchor 36, with the result that these are forced outwards in the direction of the arrows 52 and mould themselves into the anchoring substrate 26. A conical undercut of the anchoring hole is therefore produced, behind which the expansible limbs 46 of the anchor 36 engage. The hollow cone 42 is expanded in the process and can be cylindrical at the end of anchoring.

FIG. 3 shows an anchor 54 according to the invention, which is in the form of a concrete screw likewise denoted by the reference numeral 54. The concrete screw 54 forms a tool, that is, it is clamped, for example, at a screw head 56, in a tool-holding fixture of a high-frequency drill (not illustrated), which acts with high-frequency or ultrasonic oscillations on the concrete screw 54. The ultrasonic oscillation is effected in particular as an oscillating torsional vibration in the direction of the double arrow 58, so that a screw thread 60 of the concrete screw 54 used as anchor and as tool cuts into the anchoring substrate 26, which comprises concrete, for example. In addition, possibly also exclusively, an oscillation in the axial direction can be exerted on the concrete screw 54. Provision is made for a core hole for the concrete screw 54 to be predrilled in the anchoring substrate 26, as indicated in FIG. 3 by broken lines 62, wherein the core hole 62 can be conventionally drilled or alternatively produced by ultrasonic working. It is also possible, however, to screw the concrete screw 54 as tool by ultrasonic action thereon into the anchoring substrate 26 without predrilling. To extract drilling waste, the concrete screw 54 has a suction channel 64, which is moulded as a longitudinal groove into the shank of the concrete screw 54. The groove forming the suction channel 64 interrupts the screw thread 60, whereby end cutting edges are formed on the screw turns, which improve thread tapping in the anchoring substrate 26 by the ultrasonic rotary oscillations.

FIG. 4 shows a further anchor 66 according to the invention in the form of an expansion anchor having a shank 68, which has a screw thread 70 at its rear end and an expander cone 72 at its leading end. An expansible sleeve 74 having a continuous longitudinal slit is positioned on the shank 68. The anchor 66 from FIG. 4 also forms in accordance with the invention a tool for oscillatory working; it can be clamped with its rear end having the screw thread 70 into a high-frequency drill (not illustrated) in order to produce an anchoring hole by oscillatory working in an anchoring substrate. After producing the anchoring hole, the shank 68 is retracted and the expander cone 72 is consequently drawn into the expansible sleeve 74 and expands it. The anchor 66 is thereby anchored in the anchoring hole produced by oscillatory working.

To clean the anchoring hole, the anchor has a suction channel 76, which is in the form of a longitudinal groove. The suction channel 76 is formed sectionwise only in those portions of the anchor 66 in which the diameter of the anchor 66 is largest. The continuous longitudinal slit of the expansible sleeve 74 also forms a portion of the suction channel 76.

At its leading end, the expander cone 72 has a short cylindrical portion 78. The cylindrical portion 78 forms an added wearing part for wear of the anchor 66 forming the tool during preparation of the anchoring hole by oscillatory working. This applies also to the cylindrical portion 20 at the leading end of the expander cone 18 of the anchor 10 from FIG. 1.

FIG. 5 shows in a perspective overview representation an electric drill 1 according to the invention, which, with an oscillation exciter 3 and what is termed a booster 82, is in the form of a vibration drill for subjecting a workpiece to mechanical oscillations. The drill 1 has a handle 80 and an electrical connecting cable 21. The booster 82, also referred to as an amplitude transformation unit, transfers mechanical oscillations generated by the oscillation exciter 3 to the tool and influences, especially increases, the amplitude thereof, possibly by a multiple. At the tool-side end 23 of the drill 1, there is provided a chuck 5, in which an anchor as the tool 2 is clamped statically fixed and, in particular in relation to the drill 1, secured against rotation. One of the above-described anchors 10, 36, 54, 66 can be used as the tool. In the exemplary embodiment shown, the handle 80 is secured to the oscillation exciter 3 so that the oscillations are damped, but can alternatively, for example, be correspondingly fixed to the booster 82.

In the exemplary embodiment shown, the oscillation exciter 3 is in the form of a piezo exciter 4, which is supplied with electrical energy from an electrical oscillation generator (not illustrated) via the connecting cable 21. A mains operation or alternatively a battery operation can be provided for this purpose. The mechanical oscillations generated by the piezo exciter 4 by electrical excitation are increased in their amplitude by means of the booster 82 and transferred to the drilling tool 2 clamped in the chuck 5.

In the exemplary embodiment shown, the exciter frequencies of the piezo exciter 4 are in the ultrasonic range at about 20 kHz. The anchor clamped fixedly at one end as the tool 2 is designed in its natural oscillation frequencies so that at least with one eigenmode it is in resonance with the exciter frequency of the piezo exciter 4. The geometric construction of the tool 2 is here advantageously chosen so that several eigenmodes are close to each other in frequency, the correspondingly matched piezo exciter 4 effecting a resonance excitation of the different eigenmodes. Longitudinal, transversal and torsional oscillations come into consideration here.

The tool 2 is in the form of a cylindrical anchor 17 of steel with a body 31 and a threaded rod 19 held therein. The anchor 17 is here held by means of the threaded rod 19 at the chuck 5 of the drill 1. The oscillation energy of the oscillation exciter 3 is transferred from the chuck 5 via the threaded rod 19 to the body 31 of the anchor 17. The threaded rod 19 and the body 31 are coated externally and internally and hence also on their mutual contact surfaces over their entire surface. The anchor 17 is intended as an expansion anchor or expansible fixing for gripping fixing in an anchoring substrate 13 described in more detail in connection with FIG. 8. A construction as a toggle or hinged fixing for interlocking undercutting of a plasterboard panel or the like can also be advantageous. The free end 25 of the anchor 17 is in the form of a drill head 9, which has the same cylindrical external contour as an adjoining shank 8 of the anchor 17.

The drill head 9 arranged on the shank 8 of the anchor 17 used as the tool 2 is able to abrade material in axial, radial and circumferential directions by means of the corresponding oscillations in an anchoring hole 28 being produced.

In the region of the apparatus end of the tool 2 there is provided a collector 6, the interior of which is in fluid-conducting connection with a suction/flushing channel 7 running on the inside coaxially through the tool 2. To form the suction/flushing channel 7, the threaded rod 19 and the body 31 are of tubular construction. The suction/flushing channel 7 can alternatively be arranged as an external groove on the anchor 17. The collector 6 comprises a lateral connection opening 80, via which the drilling waste can be extracted by suction from the front-end orifice of the suction/flushing channel 7 away from the region of the drill head 9. Conversely, air can also be blown through the connection opening 80 and the suction/flushing channel 7 into the anchoring hole to be produced. Similarly, a drilling fluid, for example, in the form of water with an abrasive drilling auxiliary such as diamond powder or the like, can be introduced into the anchoring hole directly into the region of the drilling head 9 through the connection opening 80 and the suction/flushing channel 7.

FIG. 6 shows a variant of the tool 2 and the anchor 17 respectively according to FIG. 5, which is similar to the anchor 10 from FIG. 1. The threaded rod 19 engages through the anchor 17 in the longitudinal direction and in the region of its free end 25 has a conical expander head 86. A number of obliquely expanded expansible lugs 27 of the anchor 17 are distributed around the circumference of the expander head 86 and project radially with corners 12 beyond the cylindrical shank 8. Together with the expander head 86 the expansible lugs 27 form a non-circular drill head 9.

FIG. 7 shows in a schematic plan view an anchoring substrate 13, for example, of aerated concrete. Natural stone, concrete, masonry or the like as well as a hollow material, metal or a plastics material are possible. The shank 8 of the tool 2 or rather the anchor 17 (FIG. 6) has a circular cross-section 11, which internally adjoins the, for example, triangular, cross-sectional contour 10, formed by the expansible lugs 27 (FIG. 6), of the drill head 9. The cross-sectional contour 10 of the drill head 9 here projects radially in the region of the rounded corners 12 beyond the cross-section 10 of the shank 8. To produce the anchoring hole 14 shown in FIG. 8, the anchor 17 (FIG. 6) oscillating in resonance is guided in the axial direction towards the anchoring substrate 13, the anchoring hole 14 (FIG. 8) being formed by the abrasive action of the oscillating drill head 9, and its cross-sectional shape corresponding to the cross-sectional contour 10 of the drill head 9. In the exemplary embodiment shown, an anchoring hole 14 of rounded triangular cross-section is formed.

After reaching a desired anchoring depth, the drill 1 together with the tool 2 clamped in rotationally secure manner (FIG. 6) is rotated slowly around the longitudinal axis of the tool 2 until the corners 12 have reached, for example, the position according to FIG. 7 denoted by a broken line and marked with 12′. By continued rotation of the drill 1, the corners 12 produce an approximately circular undercut 16 compared with the triangular cross-sectional contour 10 of the bore 14 by abrading the material of the anchoring substrate 13.

FIG. 8 shows a schematic sectional representation of the anchoring substrate 13 along the line VII-VII according to FIG. 7. According to this, the radially and conically widened undercut 16, in which the anchor 17 according to FIG. 6 is secured with an interlocking and gripping fit, is formed at the bottom of the anchoring hole 14.

The anchor 17 receives the threaded rod 19. A workpiece 55 (sketched in) is held on the threaded rod 19, and, by tightening the screw connection, in addition to the interlocking at the undercut 16 a clamping effect occurs through expansion of the expansible lugs 27 by means of the expander head 86.

The drill hole 14 is drilled with the anchor 17, which has been set oscillating. After a desired drilling depth t has been reached and the bayonet-type rotary movement according to FIG. 7 has been completed, the anchor 17 is released from the chuck 5 of the drill 1 (FIG. 5), the anchor 17 remaining in the anchoring hole 14. Comparable production of the anchoring hole 14 and introduction of the anchor 17 is achieved also for a cylindrical form of the anchor 17 according to FIG. 5; the difference simply being that no undercut 16 is formed.

FIG. 9 shows an alternative of the drill according to FIG. 5, in which a further collector 6 surrounding the body 31 of the anchor 17 is provided in addition to the collector 6 in the region of the chuck 5. The anchor 17 has an internally running suction/flushing channel 7, which runs longitudinally through the anchor 17 starting from the free end 25 and is connected to the collector 6 on the machine side. On the outside of the body 31 there is provided a further, here helically running, suction/flushing channel 7, which is in fluid-conducting connection with a connection opening 84 of the collector 6 surrounding the body 31.

The anchor-side collector 6, of which for the sake of clarity only one half is shown in a sectional representation, is provided on its end face 35 in the drilling direction with a sealing ring 96 annularly surrounding the anchor 17. As a bore is being made, the sealing ring 96 is pressed against the anchoring substrate 13 (FIG. 8), thereby forming a closed, fluid-conducting connection between the two collectors 6 via the two suction/flushing channels 7 of the anchor 17. In the process, air or a drilling fluid can be pumped and/or sucked either from the outside to the inside, i.e. from the anchor-side collector 6 to the machine-side collector 7 or in the reverse direction. In the region of the free end 25 of the anchor 17 there is formed a closed, fluid-conducting system, from which the loosened drilling waste or the like can be removed at least more or less completely.

On its side facing the drill 1, the anchor 17 has an auxiliary pin 92 (FIG. 9), with which the anchor 17 is retained on the chuck 5. At its anchor-side end, the chuck 5 is in the form of a quick-action chuck operable without tools, which in the exemplary embodiment shown is in the form of a collet 29. The chuck 5 is at the same time made of a material having a low sound absorption, for which purpose titanium or a titanium alloy is selected in the exemplary embodiment shown.

FIG. 10 shows in a detail view, to an enlarged scale, the body 31 of the anchor 17 in FIG. 9, with its externally arranged suction/flushing channel 7 in the form of a groove running helically in the axial direction. The body 31 is shown in its undeformed state and in this state has a substantially cylindrical form, which extends over the entire length of the body 31 including the drill head 9 positioned at the free end 25 (FIG. 9). In the region of the drill head 9 the body 31 has, for example, four longitudinal slits 33, which run parallel to the longitudinal axis of the body 31 for instance over half the length thereof. In so doing, they divide the wall of the tubular body 31 into four expansible lugs 27 separated from one another.

A front face 94 of the drill head 9 is of concavely curved construction, forming a concave tapered surface 37 in the exemplary embodiment shown. It may also be advantageous to provide the expansible lugs 27 with obliquely inwardly set flat surfaces, with a spherical cap-shaped surface or the like. At the transition of the tapered surface 37 to the generated surface of the cylindrical body 31 an annular cutting edge 38 is formed.

From the functional co-operation of the cutting edge 38 with the tapered surface 37 and the longitudinal slits 33 a construction of the body 31 is produced in which the drill head 9 automatically expands during drilling. The contact pressure applied to the tapered surface 37 during drilling acts via the oblique position of the tapered surface 37 relative to the longitudinal axis of the body 31 with a radial, outwardly directed force component on the expansible lugs 27. In the process, as the drilling depth increases, the expansible lugs 27 undergo a radial expansion, the widening cutting edge 38 in particular bringing about a conical bore form widening in the drilling direction. In the deformed state, the expansible lugs 27 are expanded outwards and thus lead to an interlocking anchoring in the anchoring hole widening conically in the bore direction.

The body 31 of the anchor 17 is manufactured from a soft magnetic iron material and can consequently be temporarily clamped with or without the auxiliary pin 92 (FIG. 9) by virtue of magnetic retention force to a magnetic retainer 30 described in more detail in conjunction with FIG. 12.

In an illustration to an enlarged scale, FIG. 11 shows details of the chuck 5 shown in FIG. 9 with the anchor-side collet 29. The collet 29 comprises a number of gripping lugs 39, around which a clamping ring 98 of internally conical form engages. The gripping lugs 39 and the clamping ring 98 enclose an opening 41, into which the anchor 17, for example, with the threaded rod 19 as shown in FIG. 5 or the auxiliary pin 92 as shown in FIG. 9, can be introduced free from play. Owing to its tapered inner surface, a screwing action or a bayonet-type rotation of the clamping ring 98 causes a radially inward compression of the gripping lugs 39, in consequence of which the anchor 17 is firmly clamped. A tool-free release can be effected by rotation of the clamping ring 98 in the reverse direction.

In the exemplary embodiment of the chuck 5 according to FIG. 12, at the anchor-side end a magnetic retainer 30 is provided, which is of cup-form construction and surrounds the opening 41. The body 31 according to FIG. 10 or the auxiliary pin 92 of the anchor 17 according to FIG. 9 can be inserted free from play in the opening 41. The magnetic retainer 30 is in the form of a permanent magnet and is retentive by virtue of the magnetic forces arising between the permanent magnet and the anchor 17 formed from a soft magnetic material, the anchor 17 being insertable or releasable by hand without tools by overriding the magnetic forces.

FIG. 13 shows a further alternative of the chuck 5, the body of which is constructed analogously to the embodiment according to FIG. 12. At its front end an auxiliary pin 43 is provided, which in the exemplary embodiment shown has a square cross-section. An anchor 17 provided with a corresponding recess and having, for example, a body 31 according to FIG. 10, can be pushed onto the auxiliary pin 43. With a correspondingly polygonal configuration of the recess combined with the likewise polygonal cross-section of the auxiliary pin 43, a rotationally secure connection of the anchor 17 with the chuck 5 is obtained. In the longitudinal direction, the connection can be designed to be freely pulled off or to have a defined clamping force. Instead of the square construction of the auxiliary pin 43 shown, a different cross-sectional configuration other than circular can be useful, which is suitable for transferring a torque. As and when necessary, however, a circular cross-section can be provided, producing a torque-free transfer of force between the chuck 5 and the anchor 17 (FIG. 10).

1. Method for anchoring an anchor in an anchoring substrate, wherein an anchoring hole is prepared in the anchoring substrate at least partly by high-frequency mechanical oscillations, characterised in that the anchor (10; 17; 36; 54; 66) is used as tool (2) for the high-frequency oscillatory working of the anchoring substrate (13; 26).

2. Method according to claim 1, characterised in that the anchor (10; 17; 36; 54; 66) is excited at a frequency above 10 kHz and especially in the ultrasonic range.

3. Method according to claim 1, characterised in that the anchor (10; 17; 36; 54; 66) remains in the anchoring substrate (13; 26) after preparation of the anchoring hole (14; 28).

4. Method according to claim 1, characterised in that the anchor (10; 17; 36; 54; 66) is excited with a natural oscillation frequency.

5. Method according to claim 1, characterised in that the anchoring hole (14; 28) has an undercut, which is made by oscillatory working with the anchor (10; 36) as tool.

6. Method according to claim 1, characterised in that the anchoring hole has a screw thread and in that a concrete screw (54) is used as anchor and as tool with which the screw thread is produced by oscillatory working.

7. Method according to claim 1, characterised in that a fixing plug is used as anchor (10; 36; 54; 66).

8. Anchor for anchoring in an anchoring hole in an anchoring substrate, characterised in that the anchor (10; 36; 54; 66) forms a tool for at least partial preparation of an anchoring hole (28) in an anchoring substrate (13; 26) by high-frequency oscillatory working of the anchoring substrate (13; 26).

9. Anchor according to claim 8, characterised in that the anchor (10; 36; 54; 66) is matched in at least one natural oscillation frequency with the exciter frequency of a high-frequency oscillation exciter (3).

10. Anchor according to claim 8, characterised in that the anchor (10; 36; 54; 66) is an undercut expansion anchor.

11. Anchor according to claim 8, characterised in that the anchor (54) is a concrete screw.

12. Anchor according to claim 8, characterised in that the anchor (17; 54; 66) has a suction channel (7; 64; 76) for extraction by suction of drilling waste, which occurs during preparation of the anchoring hole (28) by oscillatory working.

13. Anchor according to claim 8, characterised in that the anchor (54; 66) has an auxiliary pin (92), which is provided to retain the anchor (10; 36; 54; 66) in a chuck (5) of a vibration drill (1).

14. Anchor according to claim 8, characterised in that the anchor (17) is intended for placement on an auxiliary pin (43) of a chuck (5) of a vibration drill (1).

15. Anchor according to claim 8, characterised in that the anchor (17) is constructed for magnetic fixing to a chuck (5) of a vibration drill (1).

16. Anchor according to claim 8, characterised in that the anchor (17) comprises an end (25) in the form of a drill head (9), the drill head (9) having a non-circular, laterally projecting cross-section (10).

17. Anchor according to claim 16, characterised in that the anchor (17) is of automatically expanding construction.

18. Drill, characterised in that the drill (1) is in the form of a vibration drill having a high-frequency oscillation exciter (3).

19. Drill according to claim 18, characterised in that the drill (1) is in the form of a hand tool.

20. Drill according to claim 18, characterised in that the drill (1) has a releasably clamped anchor (10; 17; 36; 54; 66), which forms a tool for preparation of an anchoring hole by high-frequency oscillatory working of an anchoring substrate (13; 26).

21. Drill according to claim 20, characterised in that the anchor (10; 17; 36; 54; 66) is matched in at least one natural oscillation frequency with the exciter frequency of the high-frequency oscillation exciter (3) of the drill (1).

22. Drill according to claim 18, characterised in that the drill (1) comprises a quick-action chuck (5) operable without tools for the anchor (17).

23. Drill according to claim 22, characterised in that the drill (1) comprises a magnetic retainer as quick-action chuck (5).

24. Drill according to claim 18, characterised in that the drill (1) has a chuck (5) with an auxiliary pin (92; 43) for attachment of the anchor (17).

25. Drill according to claim 18, characterised in that the drill (1) has a chuck (5) manufactured from a material of low sound absorption and especially of titanium.

26. Drill according to claim 18, characterised in that the drill (1) has an exciter frequency and natural oscillation frequency above 10 kHz and especially in the ultrasonic range.

27. Drill according to claim 18, characterised in that the drill (1) has a piezo exciter as oscillation exciter (3).

28. Drill according to claim 18, characterised in that the drill (1) has a suction device (6) for drilling waste.

29. Drill according to claim 18, characterised in that the drill (1) has a feed device (6) for a drilling fluid provided in particular with abrasive drilling auxiliaries.

30. Drill according to claim 18, characterised in that the suction device (6) and the feed device (6) each comprise a collector (6) which, when the anchor (10; 17; 36; 54; 66) is clamped in, is connected to a suction/flushing channel (7; 64; 76) arranged on the anchor (10; 17; 36; 54; 66).
